(19) United States
(12) Patent Application Publication
(10) Pub. No.: US 2003/0095131 A1
(43) Pub. Date: May 22, 2003

(54) Method and apparatus for processing photographic images

(76) Inventor: Michael Rondinelli, Bethel Park, PA (US)

Correspondence Address: Timothy D. Broms, Pietragallo, Bosick & Gordon, One Oxford Centre, 38th Floor, 301 Grant Street, Pittsburgh, PA, 15219, US

(21) Appl. No.: 10/289,701

(22) Filed: Nov. 7, 2002

Related U.S. Application Data
(63) Continuation-in-part of application No. 10/256,743, filed on Sep. 26, 2002.
(60) Provisional application No. 60/337,553, filed on Nov. 8, 2001.

(51) Int. Cl. G09G 5/00; G06T 15/10; G06T 15/20

(52) U.S. Cl. 345/582; 345/427

(57) ABSTRACT

The present invention provides a method of processing images including the steps of retrieving a source image file including pixel data, mapping the source image file pixel data into at least one viewable image, mapping the source image file pixel data into at least one representation of one or more dormant properties of the viewable image, and displaying cooperatively the at least one viewable image and the at least one representation of the one or more dormant properties of the viewable image. The representations of the one or more dormant properties of the viewable image may be displayed adjacent to the viewable image, overlaid on the viewable image, and/or the viewable image may be transformed into a representation of the one or more dormant properties of the viewable image, and vice versa. The representations of the one or more dormant properties of the viewable image may include a perspective representation, a compass representation, an unwrapped cylinder representation, a globe representation, or a rear view mirror representation, and the dormant properties may include the panoramic nature of the viewable image, the current viewing direction of the viewable image, an additional view of a surrounding scene, or action occurring in another portion of the surrounding scene. Apparatus for processing images in accordance with the method is also provided.

### CROSS-REFERENCE TO RELATED APPLICATIONS

This application is a continuation-in-part of U.S. patent application Ser. No. 10/256,743 filed Sep. 26, 2002, which is incorporated herein by reference. This application also claims the benefit of U.S. Provisional Application Serial No. 60/337,553 filed Nov. 8, 2001.

### FIELD OF THE INVENTION

The present invention relates to methods and apparatus for processing photographic images, and more particularly to methods and apparatus for making the images more suitable for user interaction and viewing.

### BACKGROUND INFORMATION

Recent work has shown the benefits of panoramic imaging, which is able to capture a large azimuth view with a significant elevation angle. If instead of providing a small conic section of a view, a camera could capture an entire half-sphere or more at once, several advantages could be realized. Specifically, if the entire environment is visible at the same time, it is not necessary to move the camera to fixate on an object of interest or to perform exploratory camera movements. Additionally, this means that it is not necessary to stitch multiple, individual images together to form a panoramic image. This also means that the same panoramic image or panoramic video can be supplied to multiple viewers, and each viewer can view a different portion of the image or video, independent from the other viewers.

One method for capturing a large field of view in a single image is to use an ultra-wide angle lens. A drawback to this is the fact that a typical 180-degree lens can cause substantial amounts of optical distortion in the resulting image.

A video or still camera placed below a convex reflective surface can provide a large field of view provided an appropriate mirror shape is used. Such a configuration is suited to miniaturization and can be produced relatively inexpensively. Spherical mirrors have been used in such panoramic imaging systems. Spherical mirrors have constant curvatures and are easy to manufacture, but do not provide optimal imaging or resolution.

Hyperboloidal mirrors have been proposed for use in panoramic imaging systems. The rays of light which are reflected off of the hyperboloidal surface, no matter where the point of origin, all converge at a single point, enabling perspective viewing. A major drawback to this system lies in the fact that the rays of light that make up the reflected image converge at the focal point of the reflector. As a result, positioning of the sensor relative to the reflecting surface is critical, and even a slight disturbance of the mirror will impair the quality of the image. Another disadvantage is that the use of a perspective-projections model inherently requires that, as the distance between the sensor and the mirror increases, the cross-section of the mirror must increase. Therefore, in order to keep the mirror at a reasonable size, the mirror must be placed close to the sensor. This causes complications to arise with respect to the design of the image sensor optics.

Another proposed panoramic imaging system uses a parabolic mirror and an orthographic lens for producing perspective images. A disadvantage of this system is that many of the light rays are not orthographically reflected by the parabolic mirror. Therefore, the system requires an orthographic lens to be used with the parabolic mirror.

The use of equi-angular mirrors has been proposed for panoramic imaging systems. Equi-angular mirrors are designed so that each pixel spans an equal angle irrespective of its distance from the center of the image. An equi-angular mirror such as this can provide a resolution superior to the systems discussed above. However, when this system is combined with a camera lens, the combination of the lens and the equi-angular mirror is no longer a projective device, and each pixel does not span exactly the same angle. Therefore, the resolution of the equi-angular mirror is reduced when the mirror is combined with a camera lens.

Ollis, Herman, and Singh, “Analysis and Design of Panoramic Stereo Vision Using Equi-Angular Pixel Cameras”, CMU-RI-TR-99-04, Technical Report, Robotics Institute, Carnegie Mellon University, January 1999, disclose an improved equi-angular mirror that is specifically shaped to account for the perspective effect a camera lens adds when it is combined with such a mirror. This improved equi-angular mirror mounted in front of a camera lens provides a simple system for producing panoramic images that have a very high resolution. However, this system does not take into account the fact that there may be certain areas of the resulting panoramic image that a viewer may have no desire to see. Therefore, some of the superior image resolution resources of the mirror are wasted on non-usable portions of the image.

Raw panoramic images produced by such camera systems are typically not suitable for viewing. These raw panoramic images can be made more suitable for viewing by presenting the images, for example, as a perspective view or partial cylindrical view, and the viewing direction may be adjusted by a user using an input control device such as a mouse, keyboard or joystick. However, there are disadvantages to this style of presentation. Since a perspective projection of a panoramic image looks very similar to a conventional image, discovery of the panoramic capabilities may not always be obvious to the novice user. The effect of adjusting the viewing direction and “spinning” around in a panoramic image can also be a disorienting experience without having a visual reference of the viewing direction. Additionally, when a user has chosen a particular viewing direction for viewing panoramic video, it can be easy to miss action happening in another direction without an appropriate indication.

The present invention has been developed in view of the foregoing and to address other deficiencies of the prior art.

### SUMMARY OF THE INVENTION

The present invention provides methods and apparatus for making images more suitable for user interaction and viewing.

The invention provides a method of processing images including the steps of retrieving a source image file including pixel data, mapping the source image file pixel data into a viewable image, mapping the source image file pixel data into a representation of one or more dormant properties of the viewable image, and displaying cooperatively the viewable image and the representation of the one or more dormant properties of the viewable image.

The invention also encompasses an apparatus for processing images including means for retrieving a source image file including pixel data, a processor for mapping the source image file pixel data into a viewable image and for mapping the source image file pixel data into a representation of one or more dormant properties of the viewable image, and means for cooperatively displaying the viewable image and the representation of the one or more dormant properties of the viewable image.

The invention can also provide a method of processing panoramic images including the steps of retrieving a panoramic source image file including pixel data, mapping the panoramic source image file pixel data into a viewable perspective image, mapping the panoramic source image file pixel data into at least one representation of one or more dormant properties of the viewable perspective image, and displaying cooperatively the perspective viewable image and the at least one representation of the one or more dormant properties of the perspective viewable image.

The invention can also provide an apparatus for processing images including means for retrieving a panoramic source image file including pixel data, a processor for mapping the panoramic source image file pixel data into a viewable perspective image and for mapping the panoramic source image file pixel data into at least one representation of one or more dormant properties of the viewable perspective image, and means for cooperatively displaying the viewable perspective image and the at least one representation of the one or more dormant properties of the viewable perspective image.

The invention can further provide a method of processing images including the steps of creating a texture map memory buffer including pixel data from a source image, producing a plurality of vertices for a primary model of a viewable image, wherein the vertices are representative of one or more points corresponding to one or more space vectors of the source image, computing one or more texture map coordinates for each of the vertices of the primary model, wherein the one or more texture map coordinates are representative of one or more pieces of pixel data in the texture map memory buffer corresponding to one or more pieces of pixel data in the source image, producing a plurality of vertices for a secondary model of a representation of one or more dormant properties of the viewable image, wherein the vertices are representative of one or more points corresponding to one or more space vectors of the source image, transferring the primary model and the secondary model, including the vertices and the one or more texture map coordinates, to a graphics hardware device, and instructing the graphics hardware device to use the pixel data to complete the primary model and the secondary model and to cooperatively display the completed models as the viewable image and the representation of the one or more dormant properties of the viewable image.

The invention can also provide an apparatus for processing images including a processor for creating a texture map memory buffer including pixel data from a source image, for producing a plurality of vertices for a primary model of a viewable image, wherein the vertices are representative of one or more points corresponding to one or more space vectors of the source image, for computing one or more texture map coordinates for each of the vertices of the primary model, wherein the one or more texture map coordinates are representative of one or more pieces of pixel data in the texture map memory buffer corresponding to one or more pieces of pixel data in the source image, and for producing a plurality of vertices for a secondary model of a representation of one or more dormant properties of the viewable image, wherein the vertices are representative of one or more points corresponding to one or more space vectors of the source image, and a graphics hardware device for receiving the primary model and the secondary model, including the vertices and the one or more texture map coordinates, for utilizing the pixel data to complete the primary model and the secondary model, and for cooperatively displaying the completed models as the viewable image and the representation of the one or more dormant properties of the viewable image.

The invention can also provide a method of processing images including the steps of creating a texture map memory buffer including pixel data from a source image, producing a plurality of vertices for a model of a viewable image, wherein the vertices are representative of one or more points corresponding to one or more space vectors of the source image, computing a first set of one or more texture map coordinates for each of the vertices of the model, wherein the first set of texture map coordinates is representative of one or more pieces of pixel data in the texture map memory buffer corresponding to one or more pieces of pixel data in the source image, computing a second set of one or more texture map coordinates for at least a portion of the vertices of the model, wherein the second set of texture map coordinates is representative of one or more pieces of pixel data in the texture map memory buffer corresponding to one or more pieces of pixel data in the source image, transferring the model, including the vertices and first and second set of texture map coordinates, to a graphics hardware device, and instructing the graphics hardware device to use the pixel data to complete the model and to display the completed model as the viewable image and a representation of one or more dormant properties of the viewable image.

The invention can further provide an apparatus for processing images including a processor for creating a texture map memory buffer including pixel data from a source image, for producing a plurality of vertices for a model of a viewable image, wherein the vertices are representative of one or more points corresponding to one or more space vectors of the source image, for computing a first set of one or more texture map coordinates for each of the vertices of the model, wherein the first set of texture map coordinates is representative of one or more pieces of pixel data in the texture map memory buffer corresponding to one or more pieces of pixel data in the source image, and for computing a second set of one or more texture map coordinates for at least a portion of the vertices of the model, wherein the second set of texture map coordinates is representative of one or more pieces of pixel data in the texture map memory buffer corresponding to one or more pieces of pixel data in the source image, and a graphics hardware device for receiving the model, including the vertices and the first and second set of texture map coordinates, for utilizing the pixel data to complete the model, and for displaying the completed model as the viewable image and a representation of one or more dormant properties of the viewable image.

Multiple viewable images and/or multiple representations of dormant properties of the viewable images may also be processed with the present invention.

These and other aspects of the present invention will be more apparent from the following description.

### BRIEF DESCRIPTION OF THE DRAWINGS

FIG. 1 is a schematic representation of a system for producing panoramic images that can utilize the invention;

FIG. 2 is a schematic diagram illustrating how vertices and texture map coordinates may be used to produce a virtual model in accordance with an embodiment of the present invention.

FIG. 3 is a flow diagram that illustrates a particular example of a method of the invention.

FIGS. 4-13c are schematic representations of panoramic images in accordance with embodiments of the present invention.

### DETAILED DESCRIPTION OF THE INVENTION

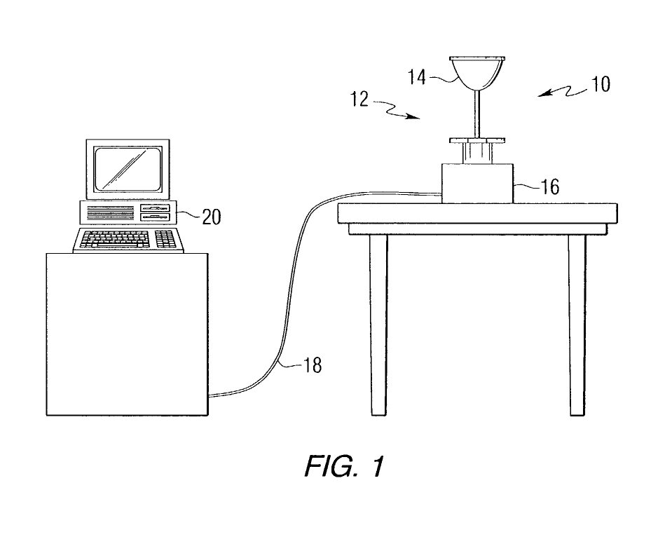

The present invention provides methods and apparatus for processing images represented in electronic form. Referring to the drawings, FIG. 1 is a schematic representation of a system 10 for producing panoramic images that can utilize the invention. The system includes a panoramic imaging device 12, which can be a panoramic camera system as disclosed in U.S. Provisional Application Serial No. 60/271,154 filed Feb. 24, 2001, and a commonly owned United States Patent Application titled “Improved Panoramic Mirror And System For Producing Enhanced Panoramic Images”, filed Feb. 22, 2002 and hereby incorporated by reference. The panoramic imaging device 12 can include an equi-angular mirror 14 and a camera 16 that cooperate to produce an image in the form of a two-dimensional array of pixels. In one embodiment, a digital converter device, such as a DV or IIDC digital camera connected through an IEEE-1394 bus, may be used to convert the captured image into pixel data. In another embodiment, the camera may be analog, and a digital converter device such as an analog to digital converter may be used to convert the captured image into pixel data. For the purposes of this invention, the pixels are considered to be an abstract data type to allow for the large variety of color models, encodings and bit depths. Each pixel can be represented as a data word, for example a pixel can be a 32-bit value consisting of four 8-bit channels: representing alpha, red, green and blue information. The image data can be transferred, for example by way of a cable 18 or wireless link, to a computer 20 for processing in accordance with this invention. Alternatively, the image data can be transferred over the Internet or other computer network to a computer 20 or other processing means for processing. In one embodiment, the image data may be transferred to a server computer for processing in a client-server computer network, as disclosed in copending commonly owned U.S. patent application Ser. No. 10/081,433 filed Feb. 22, 2002, which is hereby incorporated by reference. Such processing may include, for example, converting or mapping the raw 2-dimensional array of pixels captured with the panoramic imaging device into an image suitable for viewing, hereinafter referred to as a “viewable image”.

In one embodiment of the invention, image processing may be performed using a software application, hereinafter called VideoWarp, that can be used on various types of computers, such as Mac OS 9, Mac OS X, and Windows platforms. This software may be combined with a graphics hardware device, such as any 3-D graphics card commonly known in the art, to process images captured with a panoramic imaging device, such as the device 12 of FIG. 1, and produce panoramic images suitable for viewing. In this particular embodiment, the combination of the VideoWarp software and the graphics hardware device provide the appropriate resources typically required for processing video, although still images may be processed too.

Typically, video is made up of a plurality of still images displayed in sequence. The images are usually displayed at a high rate of speed, sufficient to make the changing events in the individual images appear fluid and connected. A minimum image display rate is often approximately 30 images per second, although other display rates may be sufficient depending on the characteristics of the equipment used for processing the images. While software alone may be sufficient for processing the often one million or more pixels needed for a single viewable panoramic image and displaying the viewable panoramic image, software alone is typically not capable of calculating and displaying the one million or more pixels of a viewable panoramic image 30 or more times a second in order to produce a real time video feed. Therefore, in this embodiment the VideoWarp software may be used in conjunction with a graphics hardware device to process panoramic video that can be viewed and manipulated in real time, or recorded for later use, such as on a video disc (e.g. as a QuickTime movie) for storage and distribution.

The VideoWarp software preferably uses a layered structure that maximizes code reuse, and provides cross-platform functionality and expandability. The preferred embodiment of the software is written in the C and C++ languages, and uses many object-oriented methodologies. The main components of the application are the user interface, source, model, projection and renderer.

The VideoWarp Core refers to the combination of the source, model, projection and renderer classes that together do the work of the application. The interface allows users to access this functionality.

The Source component manages and retrieves frames of video data from a video source. Source is an abstract class which allows the rendering of panoramic video to be independent of the particular source chosen for display. The source can be switched at any time during the execution of VideoWarp. The source is responsible for communicating with video source devices (when applicable), retrieving frames of vided, and transferring each frame of video into a memory buffer called a texture map. The texture map may represent image data in memory in several ways. In one embodiment, each pixel may be represented by a single Red, Green and Blue channel (RGB) value. In another embodiment, pixel data may be represented by luminance values for each pixel and chroma values for a group of one or more pixels, which is commonly referred to in the art as YUV format. The source may use the most efficient means possible to represent image data on the host computer system to achieve maximum performance and quality. For example, the source will attempt to use the YUV format if the graphics hardware device appears to support the YUV format. More than one source may be utilized at any given time by the renderer to obtain a more complete field-of-view.

A source may retrieve its video data from a video camera attached to the host computer, either through an analog to digital converter device to digitize analog video signals from a video camera, or through a direct digital interface with a digital camera (such as a DV or IIDC camera connected through an IEEE-1394 bus), or a digital camera connected through a camera link interface. Additionally, the source may retrieve video data from a tape deck or external storage device made to reproduce the signals of a video camera from a recording. The source may also retrieve video data from a prerecorded video file on a computer disk, computer memory device, CD-ROM, DVD-ROM, computer network or other suitable digital storage device. The source may retrieve video data from a recorded Digital Video Disc (DVD). The source may retrieve video data from a streaming video server over a network or Internet. Additionally, the source may retrieve video data from a television broadcast.

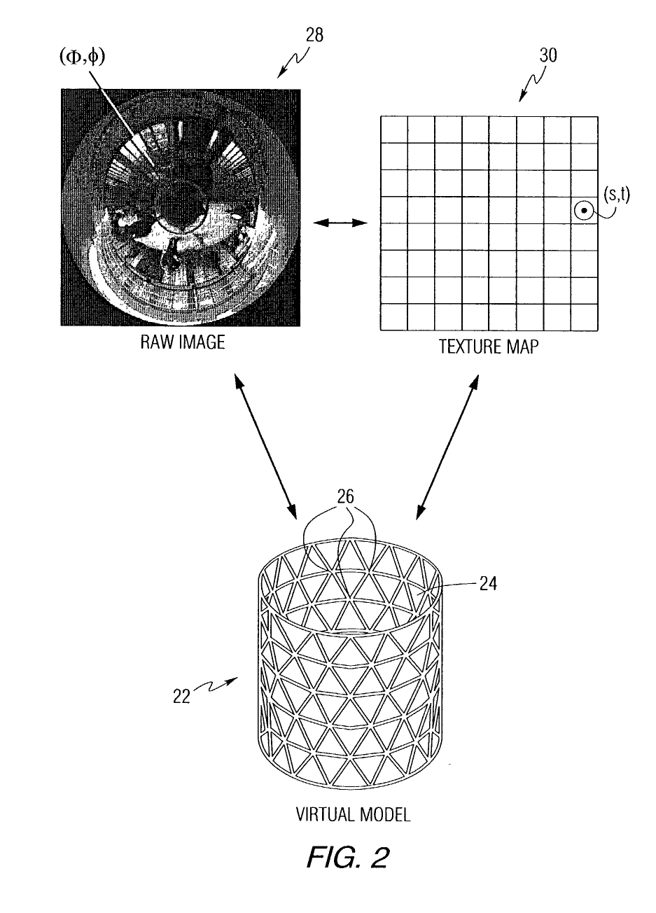

The model component is responsible for producing vertices for a virtual three-dimensional model. FIG. 2 illustrates such a virtual model 22, which can be represented by triangles 24 grouped together to form the geometry of the virtual model. The intersections of the triangles 24 are the vertices 26, and such vertices in the virtual model are points corresponding to space vectors in the raw or “warped” image 28 of FIG. 2. These vertices 26 produced by the model component essentially form a “skeleton” of the virtual model. The virtual model will typically be a representative model of the final viewable panoramic image. In this embodiment the vertices 26 of the virtual model 22 will remain constant even though the scene may be changing. This is because even though the scene may be changing, the relationship between the space vectors of the raw image and the corresponding points on the virtual model will be the same provided the model is not changed. The fact that the vertices may remain constant is an advantage, as the vertices may be determined once, and then used to produce the multiple still images needed to create the panoramic video. This will save on processor resources and may reduce the amount of time and latency associated with processing and displaying the video.

Model is an abstract class which allows the rendering of panoramic video to be independent of the particular model chosen for display. The model can be switched at any time during the execution of VideoWarp. If the model is switched, the vertices will need to be calculated again. The model may represent a cube or hexahedron, a sphere or ellipsoid, a cylinder having closed ends, an icosahedron, or any arbitrary three-dimensional model. The model preferably will encompass a 360 degree horizontal field of view from a viewpoint in the interior, and a vertical field of view between 90 degrees and 180 degrees. The model may encompass a lesser area should the coverage of the source video be less than that of the model, or to the boundary of the area to visible to the user.

The projection component is used by the model to compute texture map coordinates for each vertex in the model. Texture map coordinates refer to a particular point or location within a source texture map, which can be represented by s and t. The projection defines the relationship between each pixel in the source texture map and a direction (θ, φ) of the panoramic source image for that pixel. The direction (θ, φ) also corresponds to a particular vertex of the virtual model, as described above. Projection provides a function which converts the. (θ, φ) coordinates provided for a vertex of the model to the corresponding s and t texture map coordinate. When the viewable image is displayed, the point (s, t) of the texture map will be pinned to the corresponding vertex, producing a “skin” over the skeleton of the model which will be used to eventually reproduce substantially the entire original appearance of the captured scene to the user. This is also illustrated in FIG. 2, where a particular point (s, t) is shown on a texture map 30 and corresponds to a direction (θ, φ) of the raw source image 28 for that pixel location (s, t), and also corresponds to a vertex of the virtual model 22. In this embodiment, provided that the camera is not moved and the mirror is securely mounted so that it does not move in relation to the camera, the texture map coordinates of the virtual model 22 will remain constant even though the scene may be changing. This is because the projection of the source image and its relationship to the model remains constant. The fact that the texture map coordinates may remain constant is an advantage, as the texture map coordinates may be determined once, and then used to produce the multiple still images needed to create the panoramic video. This will also save on processor resources and may reduce the amount of time and latency associated with processing and displaying the video.

Projection is an abstract class which allows the rendering of panoramic video to be independent of the particular projection chosen to represent the source image. The parameters of the projection may be changed over time as the source video dictates. The projection itself may be changed at any time during the execution of VideoWarp. If the projection is changed, the texture map coordinates will need to be calculated again. The projection may represent an equi-angular mirror, an unrolled cylinder, an equi-rectangular map projection, the faces of a cube or other polyhedron, or any other projection which provides a 1-to-1 mapping between directional vectors. (θ, φ) and texture map coordinates (s,t).

The renderer component manages the interactions of all the other components in VideoWarp. Renderer is an abstract class which allows the rendering of panoramic video to be independent of the particular host operating system, 3D graphics framework, and 3D graphics architecture. A particular renderer is chosen which is compatible with the host computer and will achieve the maximum performance. The Renderer is in use for the lifetime of the application.

At the start of the application, the renderer uses the facilities of the host operating system to initialize the graphics hardware device, often using a framework such as OpenGL or Direct3D. The renderer may then determine the initial source, model and projection to use for the session and initializes their status. Once initialized, the renderer begins a loop to display panoramic video:

1) Determine user's preferred viewing direction.

2) Set viewing direction in graphics hardware device.

3) Determine if the model needs to be changed. Re-initialize if necessary.

4) Determine if the projection needs to be changed. Re-initialize if necessary.

5) Determine if the source needs to be changed. Re-initialize if necessary.

6) Request a frame of source video from the active source.

7) Request the graphics hardware device to draw the viewable image.

8) Repeat.

The renderer may execute some of the above processes simultaneously by using a preemptive threading architecture on the host platform. This is used to improve performance and update at a smooth, consistent rate. For example, the renderer may spawn a preemptive thread that is responsible for continually retrieving new source video frames and updating the source texture map. It may also spawn a preemptive thread responsible for issuing redraw requests to the graphics hardware device at the maximum rate possible by the hardware. Additionally, the renderer may make use of the features of a host system to execute direct memory access between the source texture map and the graphics hardware device. This typically eliminates the interaction of the computer CPU from transferring the large amounts of image data, which frees the CPU to perform other duties and may greatly improve the performance of the system. The renderer may also pass along important information about the host system to the source, model and projection components to improve performance or quality. For example, the renderer may inform the source that the graphics hardware device is compatible with YUV encoded pixel data. For many forms of digital video, YUV is the native encoding of pixel data and is more space-efficient than the standard RGB pixel format. The source can then work natively with YUV pixels, avoiding a computationally expensive conversion to RGB, saving memory and bandwidth. This will often result in considerable performance and quality improvements.

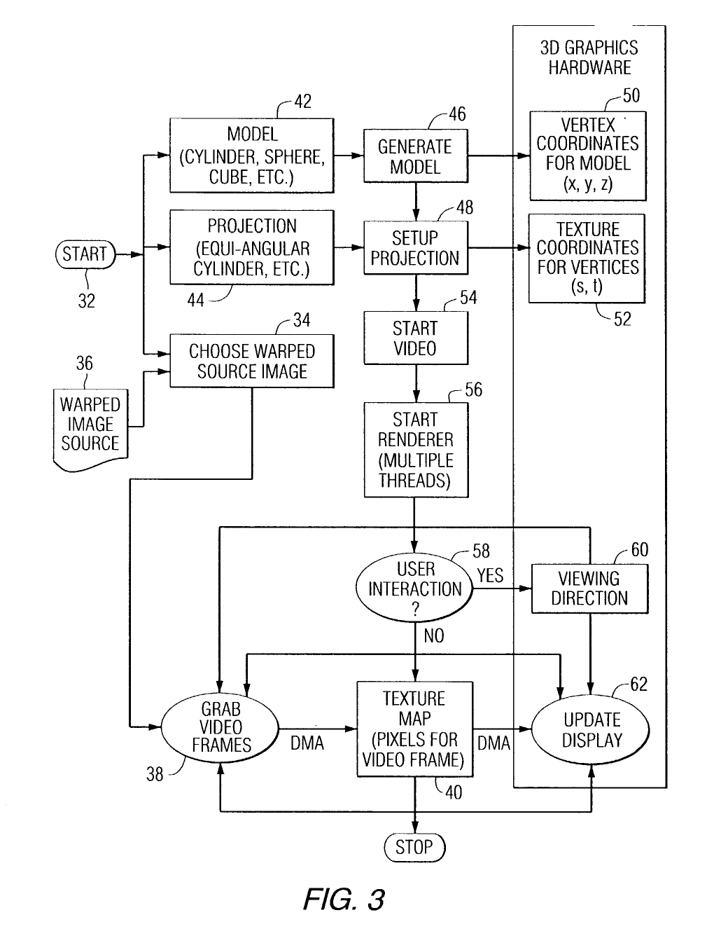

FIG. 3 is a flow diagram that illustrates a particular example of the processing method. At the start of the process, as illustrated in block 32, a warped source image is chosen as shown in block 34 from a warped image source 36. Several processes are performed to unwarp the image. In particular, block 38 shows that the warped image is “captured” by a video frame grabber, and block 40 shows that the pixel data from the source image is transferred to a texture map memory buffer as a texture map. Block 42 shows that a user or predetermined meta-data can identify a particular virtual model to use, and block 44 shows that a user or pre-determined meta-data can identify a particular projection to use. In block 46 the vertices are produced for the virtual model, and in block 48 the projection is set up by computing the texture map coordinates for the vertices of the virtual model. Next, the virtual model is transferred to a graphics hardware device by transferring the vertex coordinates as shown in block 50 and transferring the texture map coordinates as shown in block 52. Block 54 shows that video is now ready to be displayed. In particular, block 56 shows that the renderer may spawn multiple and simultaneous threads to display the video. At block 58, the renderer can determine if the user has entered particular viewing parameters, such as zooming or the particular portion of the panorama to view, as shown in block 60, and instruct the hardware to make the appropriate corrections to the virtual model. Back at block 40 the renderer can make the pixel data of the current texture map from the texture map memory buffer available to the graphics hardware device, and at block 38 the renderer can instruct the software to “capture” the next video frame and map that pixel data to the texture map memory buffer as a new texture map at block 40. The graphics hardware device will use the pixel data from the texture map memory buffer to complete the virtual model, and will update the display by displaying the completed virtual model as a viewable panoramic image as shown at block 62. In one embodiment, the graphics hardware device may utilize an interpolation scheme to “fill” in the pixels between the vertices and complete the virtual model. In this embodiment, a barycentric interpolation scheme could be used to calculate the intermediate values of the texture coordinates between the vertices. Then, a bilinear interpolation scheme could be used on the source pixels residing in the texture map to actually transfer the appropriate source pixel into the appropriate location on the model. The renderer can continue these procedures in a continuous loop until the user instructs the process to stop, or there is no longer any pixel data from the warped image source. FIG. 3 also shows that direct memory access (DMA) can be utilized if the hardware will support it. DMA can be used, for example, in allowing the texture map from the captured video frame to be directly available for the graphics hardware device to use. As noted above, the renderer may execute some of the steps simultaneously. Therefore, it is to be understood that the steps shown in the flow diagram of FIG. 3 may be not necessarily be performed in the exact order as shown and described.

The Interface layer is the part of the VideoWarp application visible to the user. It shelters the user from the complexity of the underlying core, while providing an easy to use, attractive front end for their utility. VideoWarp can provide a simple one-window interface suitable for displaying panoramic video captured with a reflective mirror optic. Specifically, VideoWarp enables the following capabilities:

Open panoramic video sources from files, attached cameras, video streams, etc.

Setting or adjusting the parameters of the source projection.

Choosing the model and display style for rendering.

Interacting with the panoramic video to choose a display view

Saving panoramic video to disk for later playback, archiving or exchange.

The implementation of the interface layer varies by host platform and operating system. The appearance of the interface is similar on all platforms to allow easy switching between platforms for users.

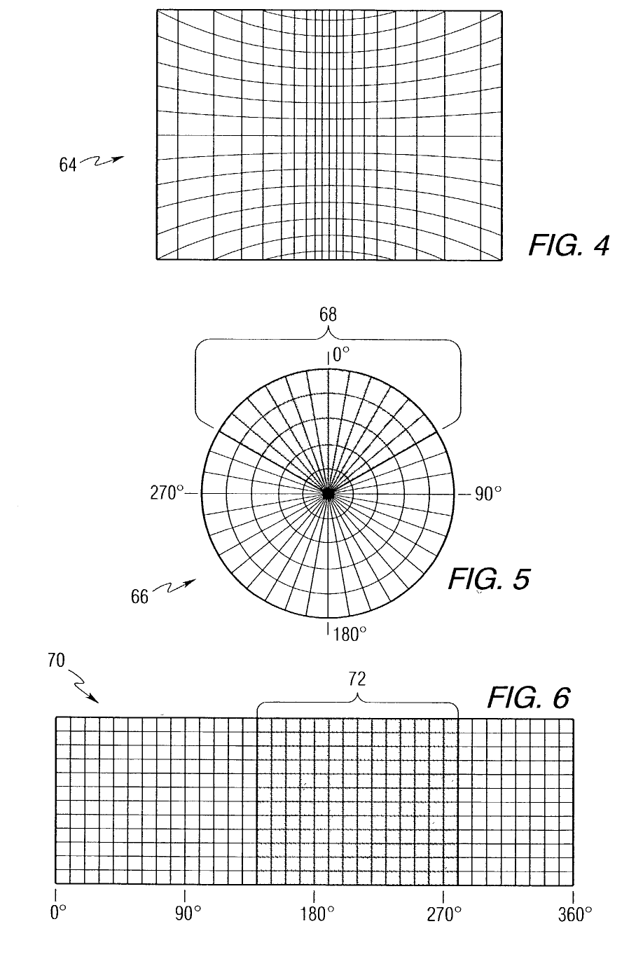

In many instances, a processing scheme such as the VideoWarp software combined with a graphics hardware device will typically process a raw image into a viewable panoramic image displayed as a perspective projection. Such a perspective projection 64 is schematically displayed in FIG. 4. Such a perspective view can be defined as a one-point perspective projection of a plane. If the source panoramic image were represented as a sphere, the perspective projection can be generated by projecting from a point in the center of the sphere onto a section plane. The source panoramic image could also be represented as other three-dimensional shapes, as described herein, and the perspective view could be generated by projecting from a point in the center onto a section plane of the three-dimensional shape. The result closely approximates the look of a conventional camera with a thin lens. Perspective projections are the most “normal” to the human eye. However, such a perspective projection cannot represent a viewable image of the entire surrounding scene at once. Since a perspective projection cannot represent the entire surrounding scene at once, there may be one or more dormant properties of the viewable panoramic image of the surrounding scene that may not be readily apparent to the user. As used herein, “dormant properties” of a viewable panoramic image refer to properties of the viewable panoramic image that may not be readily apparent to a user, such as but not limited to the panoramic nature of the image, the current viewing direction of the viewable image in relation to the surrounding scene, any peripheral or additional views of the surrounding scene, and/or action that may be occurring in another portion of the surrounding scene that the user is not aware of. A perspective projection of a panoramic image is unique in that it typically may not apprise the user or viewer of any dormant properties of the panoramic image, since the perspective view may often appear as a standard photographic image captured with a traditional camera. Other viewable forms of panoramic images may apprise the user of some, but not all, of the dormant properties of the panoramic image.

In a preferred embodiment, the present invention augments a conventional representation of a viewable panoramic image, such as a perspective representation, with one or more additional representations of viewable panoramic images. These additional representations may present dormant properties of the panoramic image in several possible forms. The representations can indicate in an intuitive manner the current viewing direction and/or any extended peripheral views of the scene. These representations can also reveal to the user the panoramic nature of the image they are looking at. In the case of panoramic video, the viewer may not be aware of action being missed while looking in a particular direction, which can defeat a major benefit of using panoramic imaging. Therefore, these representations may also readily reveal such action to a user.

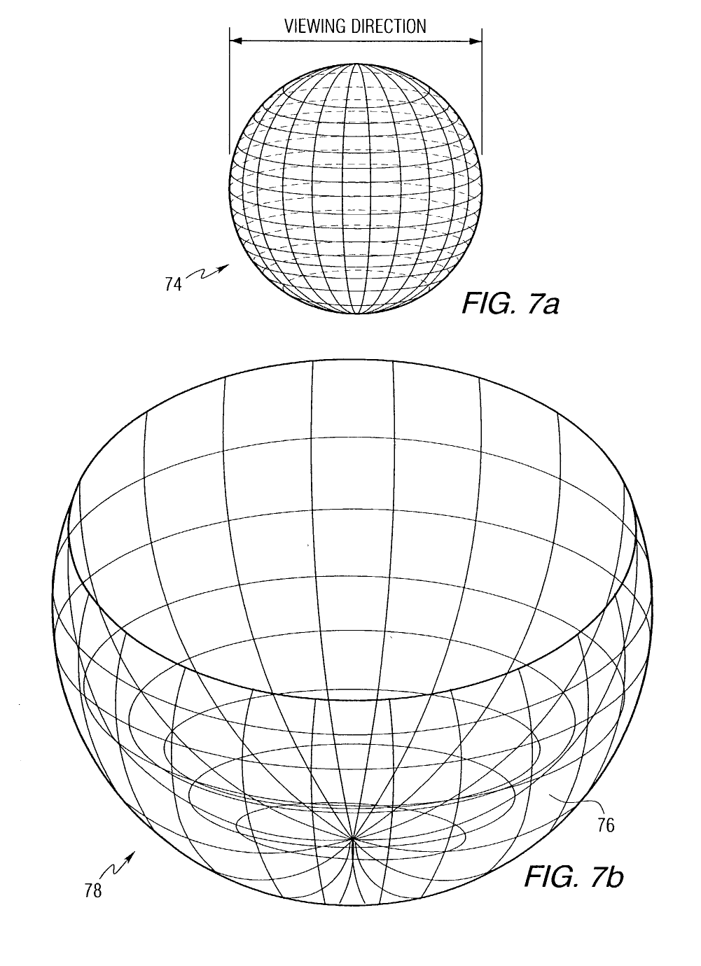

In one embodiment, a representation 66 similar to a “compass” may be used to augment a viewable panoramic image and present dormant properties, as shown in FIG. 5. Such a compass view may present a circular image containing a mapping of the entire panoramic field of view. This view is akin to a polar map projection, with the center of the circle representing “up” or “down”, and changes in latitude typically being directly proportional to the radius of the compass. In this embodiment, the current viewing direction of the surrounding scene can be indicated by one or more indicator icons, such as a highlighted wedge 68 on the circle corresponding to the current viewing direction, as illustrated in FIG. 5. The view may be presented with the pan angle fixed and the highlighted section moving with the viewpoint. Alternatively, the view may be represented with the viewing direction fixed and the surrounding circular view rotating in a corresponding fashion.

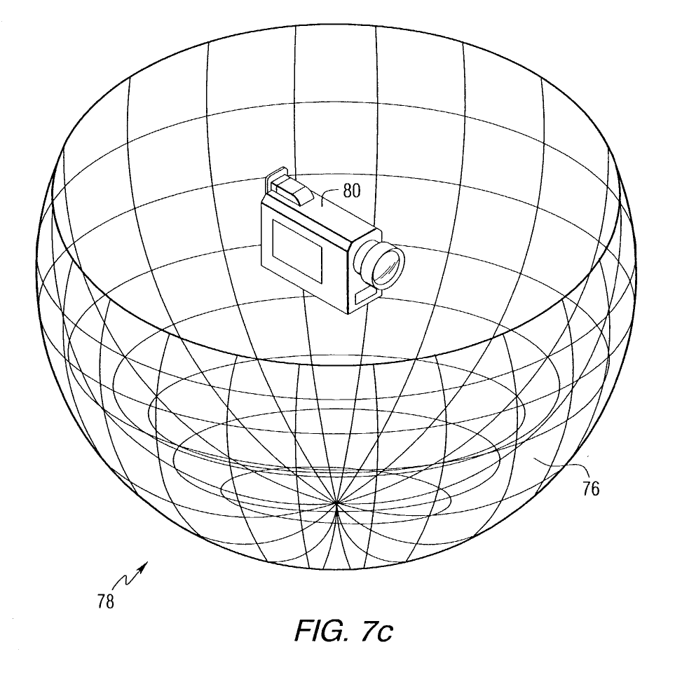

In another embodiment an “unwrapped” cylindrical projection 70 may be used to augment a viewable panoramic image, as shown in FIG. 6. In an “unwrapped” cylindrical projection the horizontal axis can proportionately represent the longitudinal angle of the surrounding scene and the vertical axis can be proportional to the latitude angle of the surrounding scene between a minimum and maximum angle. In this embodiment, the current view may be represented by a highlighted or outlined section 72 of the unwrapped cylinder. In one embodiment the cylindrical mapping may be fixed, such that the pan angle for any horizontal position is independent of the view. In a second embodiment the cylindrical mapping may be freely moveable in relation to the current viewing direction. For example, the cylindrical view could be centered about the current viewing direction. A cylindrical view has the benefit of clearly illustrating the entire panoramic image in a single view that is relatively easy to comprehend.

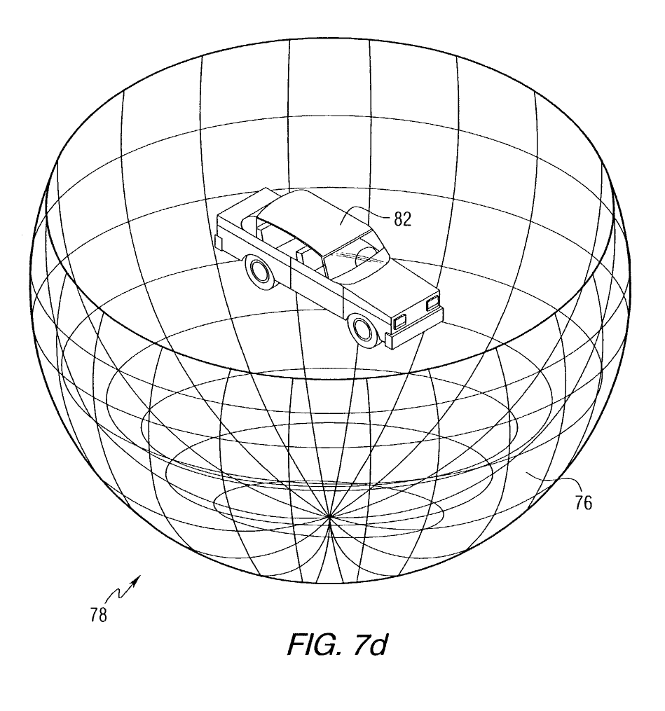

In another embodiment a three-dimensional sphere may be used to augment a viewable panoramic image, as shown in FIGS. 7a and 7b. This view is very similar to the compass view, but it “skins” the panoramic image on a virtual three-dimensional sphere or globe. Looking at the globe view, a viewer can have the impression that they can reach out and grab the sphere and turn it to a direction they would like to see. The globe view can be presented in several formats. As shown in FIG. 7a, the viewing direction can be fixed on a sphere 74 and generally be facing the viewer, giving a 180-degree peripheral view. As shown in FIG. 7b, the front face 76 of the globe 78 can be translucent, with the top of the globe cut off to give the appearance of looking into a bowl. In this embodiment the viewing direction could be facing the viewer on the outside surface of the bowl or on the inside surface. Either embodiment can have a fixed pan angle, with the current viewing direction moving around on the sphere or globe. The current viewing direction can again be represented as a highlighted region on the surface (not shown), or by a three-dimensional indicator icon associated with the sphere. FIG. 7c shows a three-dimensional model of a camera 80 could be drawn inside the sphere aimed at the current viewing direction. FIG. 7d shows that a vehicle 82 could also be used to give the impression of “driving” a vehicle in a particular direction. FIG. 7e shows a three-dimensional arrow 84 could also be used centered in the sphere, or traveling on the outside of the sphere pointing inwards. These icons may be used alone, or they may be combined with each other or with a highlighted section of the globe or sphere as described herein.

In a preferred embodiment, the panoramic image augmentation should indicate dormant properties such as the current viewing direction and an extended peripheral view of the scene in an intuitive manner. The augmentation should also reveal to the user the panoramic nature of the image they are looking at. In order to realize this embodiment, the present invention may cooperatively display one or more of the augmentations described above in unique configurations with a viewable panoramic image in a traditional form, such as a perspective projection view.

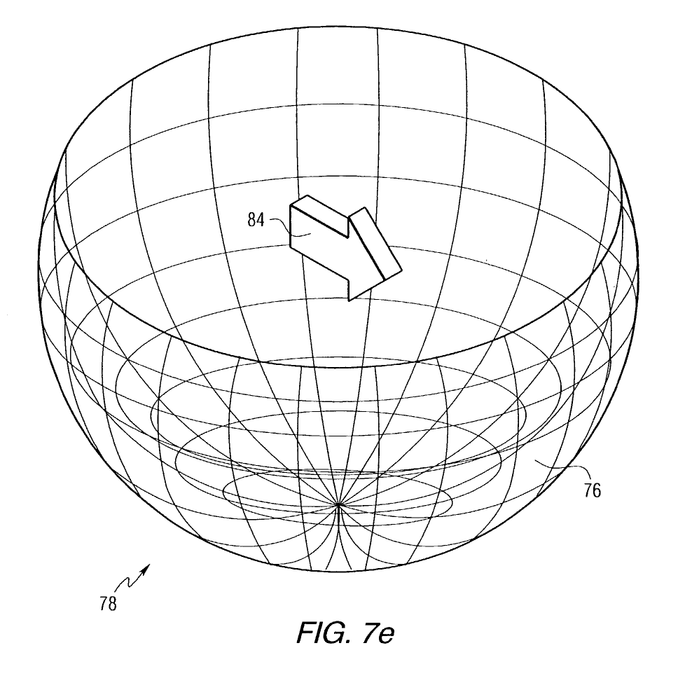

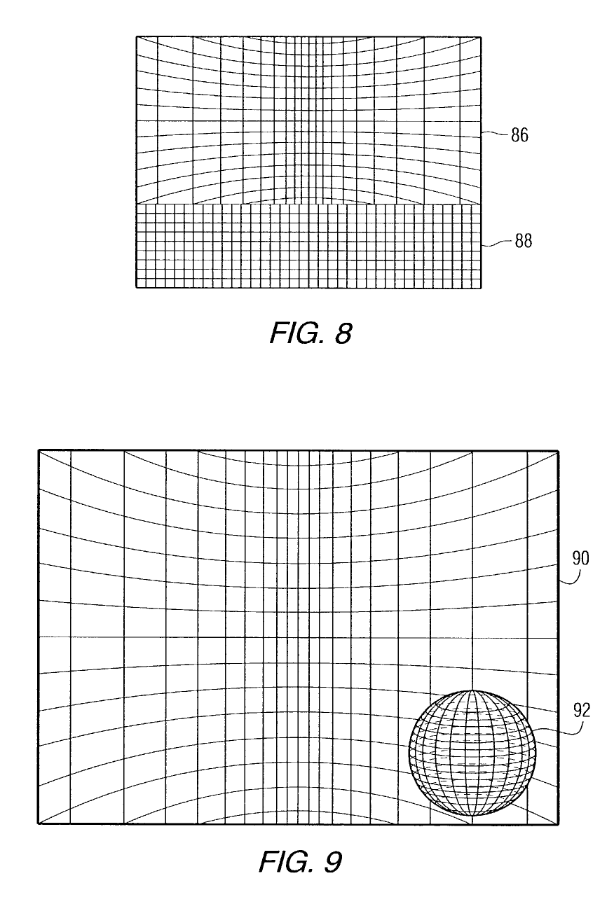

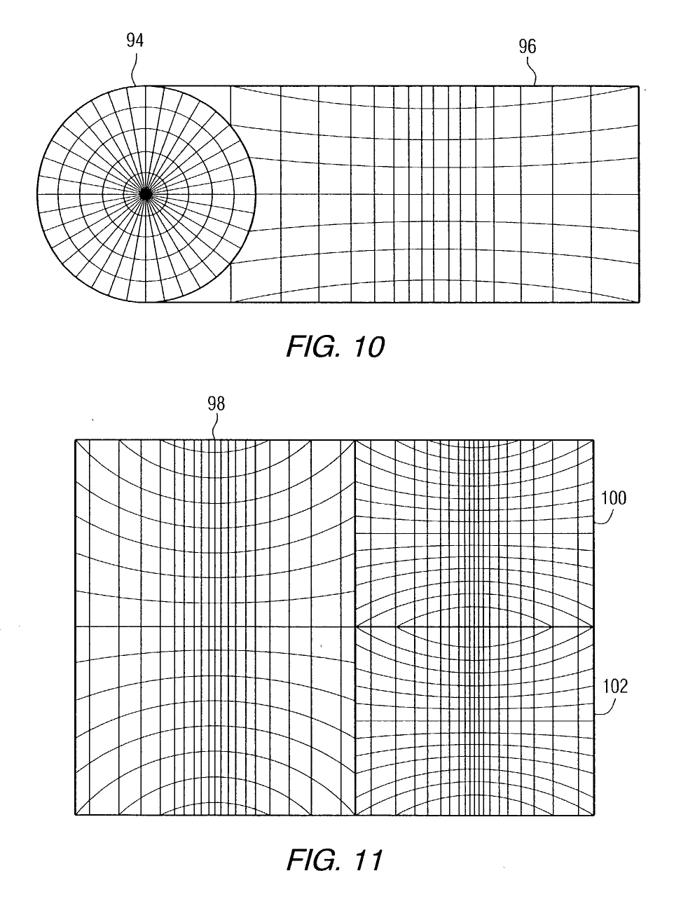

FIG. 8 shows how a perspective projection 86 and a cylindrical projection 88 can be cooperatively displayed on any suitable display device. FIG. 9 shows how a perspective projection 90 can be cooperatively displayed with a globe view 92. FIG. 10 shows how a compass view 94 can be cooperatively displayed with a partial perspective projection 96. These combinations would allow a user to view a particular portion of a surrounding scene with a traditional projection, while, for example, at the same time having access to dormant properties such as the panoramic nature of the entire surrounding scene and/or an indicator of the current viewing direction.

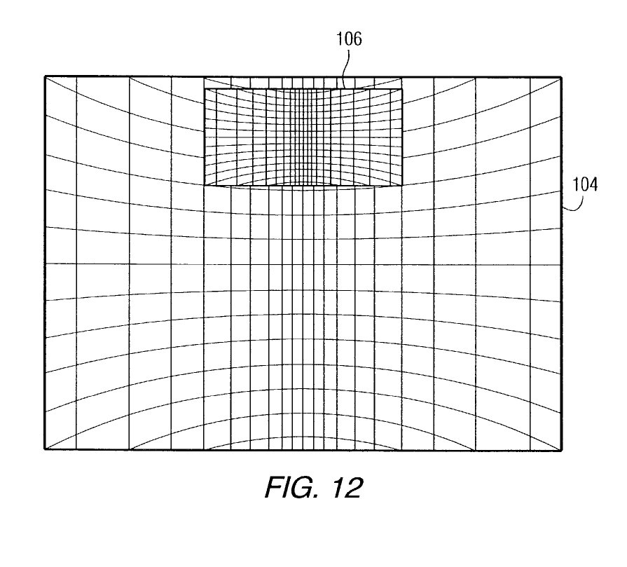

FIG. 11 shows how a viewing screen or other display device can be split and three independent perspective projections can be cooperatively displayed. In this embodiment, a single large perspective view 98 may be user controllable to look at any area of interest, while view 100 and view 102 could be fixed to look in particular directions. For example, view 100 could be fixed on the participants sitting at a conference table in a conference room, and view 102 could be fixed on a whiteboard in the conference room.

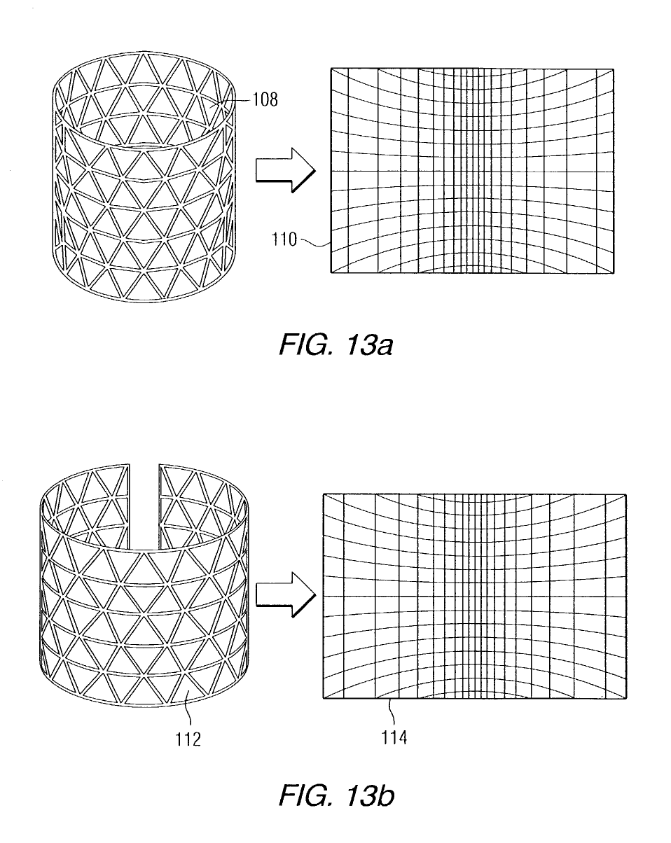

FIG. 12 shows how a main perspective projection 104 can be cooperatively displayed with a smaller secondary perspective panel 106 panned 180° from the main view to simulate a realistic “rear view mirror” that would move with the scene. Such rear view mirror 106 could be an artificial addition to the scene, or it could represent an actual rear view mirror that was in the original surrounding scene.

Such combinations of conventional representations of a viewable panoramic image and one or more additional representations of the dormant properties of the viewable panoramic image may be processed and displayed with the combination of the VideoWarp software and graphics hardware device described herein. In one embodiment, the model component of VideoWarp may be utilized to produce two or more virtual models. As an example, at least one primary virtual model may be a traditional cylindrical model with a virtual “camera” positioned at the center of its volume, producing a traditional perspective view of the surrounding scene. At least one secondary model may be, for example, a spherical or “globe” model. The spherical model could be cooperatively displayed with the cylindrical model, positioned so as to appear in a corner of the camera view, as shown in FIG. 9. Each model will typically have its own set of vertices forming the geometry of the respective model, and the vertices of each model will typically have their own set of texture map coordinates. The texture map created by the VideoWarp source component may typically be shared between the multiple models in the scene as long as only one panoramic image source is used.

VideoWarp may also be utilized to produce multiple views at once on screen with a “split screen” effect, as illustrated in FIG. 11. Most typical graphics hardware devices support the use of viewports, a concept commonly known in the art that can direct an image or a portion thereof to a particular sector of a viewing screen or other display device. The display device can be subdivided into several such viewports. Viewports may share the same graphics context and be drawn in sequence by the hardware, or may have independent graphics context which are drawn separately. Different contexts may share the same models and texture maps in memory for enhanced performance. Each viewport can be set up individually to provide views that are dependent or independent of other views in the window.

Multi-texturing may also be used with the VideoWarp software and hardware to produce multiple panoramic views overlaid on one another, such as the “rear-view mirror” embodiment of FIG. 12. In this embodiment, two or more independent sets of texture map coordinates can be applied to the vertices of the same model. Using the programmable features that are normally included with a graphics hardware device, the additional texture coordinates can be interpreted in several ways, including “blending” some portion of each texture map with the other. Such a scheme may also be used to overlay another graphical element onto the scene, such as a logo or a virtual “watermark.”

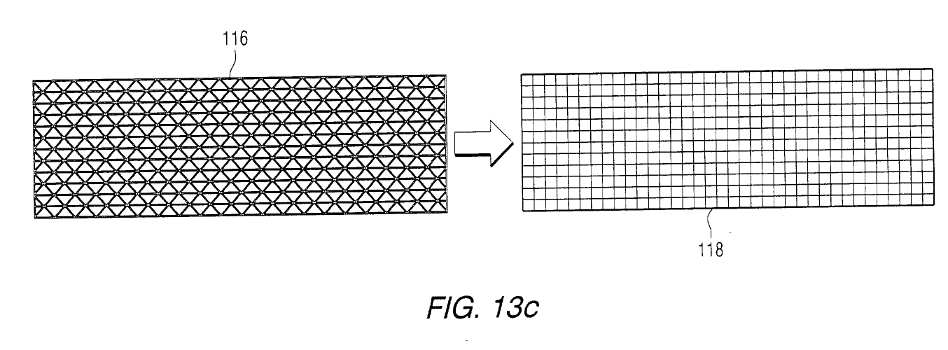

An additional effect can also be achieved by utilizing hardware and/or software, such as the VideoWarp application, to cooperatively display two views by fluidly transforming from one view to the other, such as a perspective view and an unwrapped cylinder view, by using a transitional model. A parametric virtual model may be used that carries one or more variables affecting the shape of the model itself. For example, a parameter on a transitional cylinder model can be used to “unwrap” a cylinder model, where a transition parameter value of 0 may represent a first model, such as a closed cylinder 108 for a perspective view as shown in FIG. 13a, and a value of 1 may represent a second model, such as a planar unwrapping of the cylinder 116 as shown in FIG. 13c. Intermediate parameter values may have the back end of a cylinder 112 slit vertically and the ends pulled apart to visually represent the unwrapping concept, as shown in FIG. 13b. Varying the transitional variable from 0 to 1 over time, in coordination with the camera parameters, can achieve an ultra-wide angle view effect, zooming out from a perspective view to an unwrapped cylinder. The perspective view 110 shown in FIG. 13a would be one extreme, and the unwrapped planar view 118 shown in FIG. 13c would be the other extreme. The view 114 shown in FIG. 13b represents an intermediate view of a panoramic image as the virtual model is beginning to become “unwrapped.” The effect can be reversed by varying from 1 down to 0 over time. In one embodiment, the model may be transitioned or transformed with the software. Each time the shape of the model is changed, the new model may be transferred to the graphics hardware device for displaying. In another embodiment, one or more models may be initially transferred to the graphics hardware device, and the graphics hardware device may transition the model or models. As the model or models are transitioned, new texture map coordinates may or may not need to be computed, depending on the models and the particular graphics hardware device being used.

Although the present invention has been primarily described as being used in conjunction with the VideoWarp software application, it is to be understood that the present invention may also be used as a software “plug-in” to add the image processing features and capabilities described herein to other image processing software and/or hardware. For example, the present invention may be used as a plug-in in conjunction with a method and apparatus for processing images of a scene, hereinafter called PhotoWarp, as disclosed in copending commonly owned U.S. patent application Ser. No. 10/081,545 filed Feb. 22, 2002, which is hereby incorporated by reference. PhotoWarp can expose settings to allow a content creator to choose a custom configuration of views to present to a viewer. Using the plug-in, such a customized view can be represented and tested in conjunction with these settings. In this embodiment a single photographic image may constitute the source, but the added exposure of dormant properties can improve the experience for the viewer.

In one embodiment, a customized configuration of views can be pre-determined by a content creator, and a description of the configuration can be included with the panoramic image data to inform the viewing device (a computer, software program, a television set-top box, or similar device) how to recreate the viewing configuration. For example, within a content creation software tool such as PhotoWarp or VideoWarp, each representation can be controlled with a dedicated toolset. A split tool may allow the content creator to subdivide a view and control each sub-view independently. A view tool can set the default camera viewing parameters for a view, and can determine if the view is interactive. A model tool may allow the user to drag graphical representations of various supported models onto a view, to configure the coordinate system used on that model, and to control display effects for the model (e.g. transparency or blending). Transition tools can allow predefined transitional actions to be performed on built-in models based on certain actions performed by the user (e.g. clicking a button to transition to an unwrapped cylinder). Also, a canvas tool can be dragged over the surface of a model to define areas to apply additional texture layers, which may contain the panoramic image data or another arbitrary image source. Each of the tools may provide settings to determine if the viewer may adjust the viewing setup, for example by choosing the viewing direction, resizing or rearranging sub-views, moving models or transitioning to other shapes.

Alternatively, a viewer can configure his or her own combination of views to suit his or her preferences by using such tools described above.

Although the invention has been primarily described using a limited number of configurations of the disclosed representations, it is to be understood that an unlimited number of configurations of the described representations and/or any other suitable representations can be combined and are within the scope of the present invention. It is also to be understood that the disclosed representations can be used singularly and not in combination with any of the other disclosed representations and are within the scope of the present invention.

While particular embodiments of this invention have been described above for purposes of illustration, it will be evident to those skilled in the art that numerous variations of the details of the present invention may be made without departing from the invention as defined in the appended claims.

1. A method of processing images, the method comprising the steps of:
retrieving a source image file including pixel data;
mapping the source image file pixel data into at least one viewable image;
mapping the source image file pixel data into at least one representation of one or more dormant properties of the at least one viewable image; and
displaying cooperatively the at least one viewable image and the at least one representation of the one or more dormant properties of the at least one viewable image.

2. The method of claim 1, wherein the step of displaying cooperatively the at least one viewable image and the at least one representation of the one or more dormant properties of the at least one viewable image comprises the steps of:
displaying the at least one viewable image; and
displaying the at least one representation of the one or more dormant properties of the at least one viewable image adjacent to the at least one viewable image.

3. The method of claim 1, wherein the step of displaying cooperatively the at least one viewable image and the at least one representation of the one or more dormant properties of the at least one viewable image comprises the steps of:
overlaying the at least one representation of the one or more dormant properties of the at least one viewable image onto at least a portion of the at least one viewable image; and
displaying the at least one viewable image and the at least one overlaid representation of the one or more dormant properties of the at least one viewable image.

4. The method of claim 1, wherein the step of displaying cooperatively the at least one viewable image and the at least one representation of the one or more dormant properties of the at least one viewable image comprises the steps of:
displaying the at least one viewable image; and
transforming over a period of time the at least one displayed viewable image into at least one displayed representation of the one or more dormant properties of the at least one viewable image.

5. The method of claim 1, wherein the step of displaying cooperatively the at least one viewable image and the at least one representation of the one or more dormant properties of the at least one viewable image comprises the steps of:
displaying the at least one representation of the one or more dormant properties of the at least one viewable image; and
transforming over a period of time the at least one displayed representation of the one or more dormant properties of the at least one viewable image into at least one displayed viewable image.

6. The method of claim 1, wherein the at least one representation of the one or more dormant properties of the at least one viewable image comprises: a perspective representation, a compass representation, an unwrapped cylinder representation, a globe representation, or a rear view mirror representation.

7. The method of claim 1, wherein the at least one representation of the one or more dormant properties of the at least one viewable image comprises a viewable image.

8. The method of claim 1, wherein the one or more dormant properties comprise: a panoramic nature of the viewable image, a current viewing direction of the viewable image, an additional view of a surrounding scene, or action occurring in another portion of the surrounding scene.

9. The method of claim 1, further comprising the steps of:
pre-determining the at least one viewable image and the at least one representation of the one or more dormant properties of the at least one viewable image to be cooperatively displayed; and
pre-determining how the at least one viewable image and the at least one representation of the one or more dormant properties of the at least one viewable image will be cooperatively displayed.

10. The method of claim 1, further comprising the steps of:
allowing a user to determine the at least one viewable image and the at least one representation of the one or more dormant properties of the at least one viewable image to be cooperatively displayed; and
allowing a user to determine how the at least one viewable image and the at least one representation of the one or more dormant properties of the at least one viewable image will be cooperatively displayed.

11. An apparatus for processing images, the apparatus comprising:
means for retrieving a source image file including pixel data;
a processor for mapping the source image file pixel data into at least one viewable image and for mapping the source image file pixel data into at least one representation of one or more dormant properties of the at least one viewable image; and
means for cooperatively displaying the at least one viewable image and the at least one representation of the one or more dormant properties of the at least one viewable image.

12. The apparatus of claim 11, wherein the means for cooperatively displaying the at least one viewable image and the at least one representation of the one or more dormant properties of the at least one viewable image is the processor for:
displaying the at least one viewable image; and
displaying the at least one representation of the one or more dormant properties of the at least one viewable image adjacent to the at least one viewable image.

13. The apparatus of claim 11, wherein the means for cooperatively displaying the at least one viewable image and the at least one representation of the one or more dormant properties of the at least one viewable image is the processor for:
overlaying the at least one representation of the one or more dormant properties of the at least one viewable image onto at least a portion of the at least one viewable image; and
displaying the at least one viewable image and the at least one overlaid representation of the one or more dormant properties of the at least one viewable image.

14. The apparatus of claim 11, wherein the means for cooperatively displaying the at least one viewable image and the at least one representation of the one or more dormant properties of the at least one viewable image is the processor for:
displaying the at least one viewable image; and
transforming the at least one displayed viewable image into at least one displayed representation of the one or more dormant properties of the at least one viewable image.

15. The apparatus of claim 11, wherein the means for cooperatively displaying the at least one viewable image and the at least one representation of the one or more dormant properties of the at least one viewable image is the processor for:
displaying the at least one representation of the one or more dormant properties of the at least one viewable image; and
transforming over a period of time the at least one displayed representation of the one or more dormant properties of the at least one viewable image into at least one displayed viewable image.

16. The apparatus of claim 11, wherein the at least one representation of the one or more dormant properties of the at least one viewable image comprises: a perspective representation, a compass representation, an unwrapped cylinder representation, a globe representation, or a rear view mirror representation.

17. The apparatus of claim 11, wherein the at least one representation of the one or more dormant properties of the at least one viewable image comprises a viewable image.

18. The apparatus of claim 11, wherein the one or more dormant properties comprise: a panoramic nature of the viewable image, a current viewing direction of the viewable image, an additional view of a surrounding scene, or action occurring in another portion of the surrounding scene.

19. A method of processing panoramic images, the method comprising the steps of:
retrieving a panoramic source image file including pixel data;
mapping the panoramic source image file pixel data into a viewable perspective image;
mapping the panoramic source image file pixel data into at least one representation of one or more dormant properties of the viewable perspective image; and
displaying cooperatively the perspective viewable image and the at least one representation of the one or more dormant properties of the perspective viewable image.

20. The method of claim 19, further comprising the step of:
mapping the panoramic source image file pixel data into one or more viewable perspective images.

21. An apparatus for processing panoramic images, the apparatus comprising:
means for retrieving a panoramic source image file including pixel data;
a processor for mapping the panoramic source image file pixel data into a viewable perspective image and for mapping the panoramic source image file pixel data into at least one representation of one or more dormant properties of the viewable perspective image; and
means for cooperatively displaying the viewable perspective image and the at least one representation of the one or more dormant properties of the viewable perspective image.

22. The apparatus of claim 21, wherein the processor further serves as means for mapping the panoramic source image file pixel data into one or more viewable perspective images.

23. A method of processing images, the method comprising the steps of:
creating a texture map memory buffer including pixel data from a source image;
producing a plurality of vertices for at least one primary model of at least one viewable image, wherein the vertices are representative of one or more points corresponding to one or more space vectors of the source image;
computing one or more texture map coordinates for each of the vertices of the at least one primary model, wherein the one or more texture map coordinates are representative of one or more pieces of pixel data in the texture map memory buffer corresponding to one or more pieces of pixel data in the source image;
producing a plurality of vertices for at least one secondary model of at least one representation of one or more dormant properties of the at least one viewable image, wherein the vertices are representative of one or more points corresponding to one or more space vectors of the source image;
transferring the at least one primary model and the at least one secondary model, including the vertices and the one or more texture map coordinates, to a graphics hardware device; and
instructing the graphics hardware device to use the pixel data to complete the at least one primary model and the at least one secondary model and to cooperatively display the completed models as the at least one viewable image and the at least one representation of the one or more dormant properties of the at least one viewable image.

24. The method of claim 23, further comprising the step of:
computing one or more texture map coordinates for each of the vertices of the at least one secondary model, wherein the one or more texture map coordinates are representative of one or more pieces of pixel data in the texture map memory buffer corresponding to one or more pieces of pixel data in the source image;

25. The method of claim 23, wherein one or more of the steps may be repeated sequentially to display a plurality of viewable images and representations of one or more dormant properties of the viewable images at a video frequency rate.

26. The method of claim 24, wherein the step of instructing the graphics hardware device to cooperatively display the completed models as the at least one viewable image and the at least one representation of the one or more dormant properties of the at least one viewable image comprises the steps of:
displaying the at least one viewable image; and
displaying the at least one representation of the one or more dormant properties of the at least one viewable image adjacent to the at least one viewable image.

27. The method of claim 24, wherein the step of instructing the graphics hardware device to cooperatively display the completed models as the at least one viewable image and the at least one representation of the one or more dormant properties of the at least one viewable image comprises the steps of:
overlaying the at least one representation of the one or more dormant properties of the at least one viewable image onto at least a portion of the at least one viewable image; and
displaying the at least one viewable image and the at least one overlaid representation of the one or more dormant properties of the at least one viewable image.

28. The method of claim 23, further comprising the steps of:
producing the plurality of vertices and the one or more texture map coordinates for the at least one secondary model by transforming the at least one primary model into the at least one secondary model over a period of time; and
instructing the graphics hardware device to display the at least one completed primary model as it is transformed into the at least one completed secondary model.

29. The method of claim 28, further comprising the steps of:
transforming the at least one secondary model back into the at least one primary model over a period of time; and
instructing the graphics hardware device to display the at least one completed secondary model as it is transformed back into the at least one completed primary model.

30. The method of claim 23, wherein the at least one primary model comprises one of: a cube, a hexahedron, a sphere, an ellipsoid, a cylinder, an unwrapped cylinder representation, an icosahedron, or a compass representation.

31. The method of claim 23, wherein the at least one secondary model comprises one of: a cube, a hexahedron, a sphere, an ellipsoid, a cylinder, an unwrapped cylinder representation, an icosahedron, or a compass representation.

32. The method of claim 23, wherein the one or more dormant properties comprise: a panoramic nature of the viewable image, a current viewing direction of the viewable image, an additional view of a surrounding scene, or action occurring in another portion of the surrounding scene.

33. The method of claim 23, further comprising the steps of:
pre-determining the at least one viewable image and the at least one representation of the one or more dormant properties of the at least one viewable image to be cooperatively displayed; and
pre-determining how the at least one viewable image and the at least one representation of the one or more dormant properties of the at least one viewable image will be cooperatively displayed.

34. The method of claim 23, further comprising the steps of:
allowing a user to determine the at least one viewable image and the at least one representation of the one or more dormant properties of the at least one viewable image to be cooperatively displayed; and
allowing a user to determine how the at least one viewable image and the at least one representation of the one or more dormant properties of the at least one viewable image will be cooperatively displayed.

35. An apparatus for processing images, the apparatus comprising:
a processor for creating a texture map memory buffer including pixel data from a source image, for producing a plurality of vertices for at least one primary model of at least one viewable image, wherein the vertices are representative of one or more points corresponding to one or more space vectors of the source image, for computing one or more texture map coordinates for each of the vertices of the at least one primary model, wherein the one or more texture map coordinates are representative of one or more pieces of pixel data in the texture map memory buffer corresponding to one or more pieces of pixel data in the source image, and for producing a plurality of vertices for at least one secondary model of at least one representation of one or more dormant properties of the at least one viewable image, wherein the vertices are representative of one or more points corresponding to one or more space vectors of the source image; and
a graphics hardware device for receiving the at least one primary model and the at least one secondary model, including the vertices and the one or more texture map coordinates, for utilizing the pixel data to complete the at least one primary model and the at least one secondary model, and for cooperatively displaying the completed models as the at least one viewable image and the at least one representation of the one or more dormant properties of the at least one viewable image.

36. The apparatus of claim 35, wherein the processor further serves as means for:
computing one or more texture map coordinates for each of the vertices of the at least one secondary model, wherein the one or more texture map coordinates are representative of one or more pieces of pixel data in the texture map memory buffer corresponding to one or more pieces of pixel data in the source image

37. The apparatus of claim 36, wherein the graphics hardware device further serves as means for:
displaying the at least one viewable image; and
displaying the at least one representation of the one or more dormant properties of the at least one viewable image adjacent to the at least one viewable image.

38. The apparatus of claim 36, wherein the graphics hardware device further serves as means for:
overlaying the at least one representation of the one or more dormant properties of the at least one viewable image onto at least a portion of the at least one viewable image; and
displaying the at least one viewable image and the at least one overlaid representation of the one or more dormant properties of the at least one viewable image.

39. The apparatus of claim 35, wherein the processor further serves as means for producing the plurality of vertices and the one or more texture map coordinates for the at least one secondary model by transforming the at least one primary model into the at least one secondary model; and
the graphics hardware device further serves as means for displaying the at least one primary model as it is transformed into the at least one secondary model.

40. The apparatus of claim 35, wherein the processor further serves as means for transforming the at least one secondary model back into the at least one primary model over a period of time; and
the graphics hardware device further serves as means for displaying the at least one completed secondary model as it is transformed back into the at least one completed primary model.

41. The apparatus of claim 35, wherein the at least one primary model comprises one of: a cube, a hexahedron, a sphere, an ellipsoid, a cylinder, an unwrapped cylinder representation, an icosahedron, or a compass representation.

42. The apparatus of claim 35, wherein the at least one secondary model comprises one of: a cube, a hexahedron, a sphere, an ellipsoid, a cylinder, an unwrapped cylinder representation, an icosahedron, or a compass representation.

43. The apparatus of claim 35, wherein the one or more dormant properties comprise: a panoramic nature of the viewable image, a current viewing direction of the viewable image, an additional view of a surrounding scene, or action occurring in another portion of the surrounding scene.

44. A method of processing images, the method comprising the steps of:
creating a texture map memory buffer including pixel data from a source image;
producing a plurality of vertices for at least one model of at least one viewable image, wherein the vertices are representative of one or more points corresponding to one or more space vectors of the source image;
computing a first set of one or more texture map coordinates for each of the vertices of the at least one model, wherein the first set of texture map coordinates is representative of one or more pieces of pixel data in the texture map memory buffer corresponding to one or more pieces of pixel data in the source image;
computing a second set of one or more texture map coordinates for at least a portion of the vertices of the at least one model, wherein the second set of texture map coordinates is representative of one or more pieces of pixel data in the texture map memory buffer corresponding to one or more pieces of pixel data in the source image;
transferring the at least one model, including the vertices and first and second set of texture map coordinates, to a graphics hardware device; and
instructing the graphics hardware device to use the pixel data to complete the at least one model and to display the at least one completed model as the at least one viewable image and at least one representation of one or more dormant properties of the at least one viewable image.

45. The method of claim 44, wherein one or more of the steps may be repeated sequentially to display a plurality of the viewable images and the representations of the one or more dormant properties of the viewable images, and wherein the plurality of viewable images may be displayed at a video frequency rate.

46. The method of claim 44, wherein the at least one model comprises one of: a cube, a hexahedron, a sphere, an ellipsoid, a cylinder, an unwrapped cylinder representation, an icosahedron, a compass representation, or a rear view mirror representation.

47. The method of claim 42, wherein the one or more dormant properties comprise: a panoramic nature of the viewable image, a current viewing direction of the viewable image, an additional view of a surrounding scene, or action occurring in another portion of the surrounding scene.

48. An apparatus for processing images, the apparatus comprising:
a processor for creating a texture map memory buffer including pixel data from a source image, for producing a plurality of vertices for at least one model of at least one viewable image, wherein the vertices are representative of one or more points corresponding to one or more space vectors of the source image, for computing a first set of one or more texture map coordinates for each of the vertices of the at least one model, wherein the first set of texture map coordinates is representative of one or more pieces of pixel data in the texture map memory buffer corresponding to one or more pieces of pixel data in the source image, and for computing a second set of one or more texture map coordinates for at least a portion of the vertices of the at least one model, wherein the second set of texture map coordinates is representative of one or more pieces of pixel data in the texture map memory buffer corresponding to one or more pieces of pixel data in the source image; and
a graphics hardware device for receiving the at least one model, including the vertices and first and second set of texture map coordinates, for utilizing the pixel data to complete the at least one model, and for displaying the at least one completed model as the at least one viewable image and at least one representation of one or more dormant properties of the at least one viewable image.

49. The apparatus of claim 48, wherein the at least one model comprises one of: a cube, a hexahedron, a sphere, an ellipsoid, a cylinder, an unwrapped cylinder representation, an icosahedron, a compass representation, or a rear view mirror representation.

50. The method of claim 48, wherein the one or more dormant properties comprise: a panoramic nature of the viewable image, a current viewing direction of the viewable image, an additional view of a surrounding scene, or action occurring in another portion of the surrounding scene.
